(19) United States
(12) Patent Application Publication
(10) Pub. No.: US 2005/0029864 A1
(43) Pub. Date: Feb. 10, 2005

(54) Brake system for a vehicle

(76) Inventors: Wolf-Dietrich Bauer, Leinfelden-Echteringen (DE); Carsten Haemmerling, Stuttgart (DE); Andreas Schwarzhaupt, Oberrot (DE); Gernot Spiegelberg, Heimsheim (DE); Wolfgang Stahl, Oberboihingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/490,043

(22) PCT Filed: Jul. 3, 2002
(86) PCT No.: PCT/EP02/07363

(30) Foreign Application Priority Data
Sep. 22, 2001 (DE) 10146770.2

(51) Int. Cl. B60T 7/20

(52) U.S. Cl. 303/191; 303/123

(57) ABSTRACT

A brake system for a vehicle can be operated without a driver. It has a service brake device, a parking brake device and an emergency braking device. At least the wheel brake devices of the wheels of one axle of the vehicle have emergency brake actuators which switchover the assigned wheel brake devices into the braking state as a result of the triggering of an emergency braking operation. The emergency braking operation can be triggered either manually by means of an emergency operator control device or automatically by means of a monitoring device if the latter has detected an unacceptable operating state of the vehicle in the driverless operating mode.

### BACKGROUND AND SUMMARY OF THE INVENTION

The invention relates to a brake system for a utility vehicle which can be operated without a driver and which is in particular also provided and approved for operation with a driver.

Such utility vehicles are provided, inter alia, for traffic within an enclosed site, for example works site. They move autonomously between predefined locations, essentially without the intervention of an operator or driver. The vehicle can move, for example, along a permanently predefinable route. Here, situations may occur in which a vehicle which moves without a driver has to be stopped abruptly, for example because an obstacle is unexpectedly situated on the route of the vehicles.

In such vehicles which are operated in a driverless fashion, devices are known which brake the vehicle when there is contact with an obstacle, as is apparent, for example, from DE 42 25 963 A1 or DE 92 16 134 U1.

Nowadays, utility vehicles with approval as road traffic are also intended to be used for the autonomous transportation of goods. This provides the possibility of a driver driving the vehicle as far as the works gate and the vehicle moving without a driver from the works gate to the loading point in the works, being loaded or unloaded and returning again to the works gate while the driver has his break. The vehicle can be navigated by means of a navigation system, for example using GPS. The vehicle dynamics in the longitudinal direction and transverse direction (steering, accelerating etc.) can be controlled and regulated automatically in order to move the vehicle to the desired destination (for example loading point) in accordance with the predefinable route.

Brake systems for utility vehicles which are approved as road traffic are known, for example from DE 35 21 486 A1. They have a service brake and a parking brake device, the parking brake device serving simultaneously as an auxiliary braking device which can be activated manually, so that the vehicle can be braked when the service brake device is operationally incapable.

The object of the present invention is to specify a brake system for vehicle which provides increased operating reliability for use in the driverless operating mode of the vehicle.

This object is achieved by means of a brake system described and claimed hereinafter.

With the brake system according to the invention, the emergency braking operation can not only be triggered manually but also automatically by a monitoring device which monitors the driving state of the vehicle during the driverless operating mode. As soon as the monitoring device detects an unacceptable operating state, for example a defect in the service brake or the fact that the driverless vehicle has left a predefined driving lane, said monitoring device brings about a corresponding triggering signal which triggers the emergency braking operation. This takes place in the driverless operating mode since manual intervention is not possible, or is possible only with very great difficulty. There is also the possibility of triggering the emergency braking operation manually. This may be necessary in the driverless operating mode in order to prevent collisions or when operating with a driver when the driver is not capable of intervening in the situation, for example when he has lost consciousness. Manual triggering can also be carried out by a person located in the surroundings of the vehicle, or by the front seat passenger by activation of the emergency brake operator control device.

By virtue of the monitoring device, in contrast to the known brake systems, a defect in the service brake device may already be detected before a service braking operation which does not have a braking effect, or has only an inadequate braking effect, is triggered. By means of the monitoring device, the defect in the service brake system is detected automatically and independently of a service braking operation which is brought about, and an emergency braking operation is then triggered automatically in the driverless operating mode. The emergency braking operation is also brought about if the vehicle which is operated without a driver leaves a predefined driving lane. As a result, collisions with vehicles in other driving lanes (dynamic obstacles) and static obstacles can be effectively prevented in the driverless operating mode. Overall, the brake system according to the invention provides increased safety for vehicles which are operated without a driver.

The brake system is advantageously embodied as an electro-pneumatic brake system. The electrical actuation enables autonomous deceleration to be implemented here in a simple way without manual intervention by the driver.

On the basis of the embodiment of the brake system with an emergency braking device, the brake system may be embodied with a single circuit, permitting a reduction in expenditure and costs in comparison with a dual-circuit embodiment.

The emergency brake actuators are expediently mechanically prestressed into a position of rest in such a way that when the emergency brake actuators are in the position of rest the assigned wheel brake devices are in the braking state. The wheel brake devices are capable of being switched over, by acting appropriately on the emergency brake actuators, fluidically and/or electrically between the braking state and an enabling state which enables the assigned wheels of the vehicle. This permits an emergency braking operation to be carried out even if there is no longer any electrical energy or any fluidic pressure available in the vehicle owing to a fault. The emergency brake actuators may be formed by spring brake cylinders in this case.

The emergency brake actuators may be formed by the parking brake actuators of the parking brake device, which easily makes it possible for the emergency braking device to be independent of the service brake device.

In order to warn other road users, in particular if the vehicle is in the driverless operating mode, it is possible, for example, to generate a visual and/or audible warning signal when the emergency braking operation is triggered. This warning signal can also at the same time indicate that the emergency braking operation has been triggered automatically by the service brake monitoring device, which points to a defect in the service brake device. The vehicle then has to be repaired before further operation.

It is advantageous if the drive assembly of the vehicle is switched off at the same time as the emergency braking operation is triggered so that, on the one hand, the engine torque is utilized during the emergency braking operation but at the same time no further driving force is generated in the driving direction so that the vehicle can be stopped safely and quickly.

Furthermore it is expedient if the emergency braking operation is triggered by means of an actuable electrical switch arrangement of the emergency braking device, which arrangement is located in a defined home state when in the currentless and/or voltageless state. In particular, the emergency braking operation can be triggered when the switch arrangement is in the home state, so that an emergency braking operation can be brought about even when the electrical energy in the vehicle fails.

In this context it is also possible for the drive assembly to be switched off, and/or the warning signal to be brought about, by means of the switch arrangement.

In one advantageous embodiment, the emergency braking device has a switchover device which can be actuated by the switch arrangement and is provided for switching over the wheel brake devices, provided with emergency brake actuators, between the braking state and an enabling state which enables the assigned wheels. This embodiment can be implemented with little expenditure in an electro-pneumatic brake system.

A plurality of emergency brake operator control elements which can be activated manually and, in particular, can be reached easily from outside the vehicle may be provided at various locations on the vehicle. This measure enables an emergency braking operation to be triggered by an operator, especially when the vehicle is moving without a driver and an emergency situation occurs, for example when there is an obstacle on the route.

It is also possible to provide that a coupling device is provided for coupling a trailer or semitrailer to the vehicle and has a control valve which, when the emergency braking operation is triggered, switches over at least one trailer braking device into the braking state in order to brake the assigned trailer wheels so that both the vehicle and the trailer or semitrailer are braked.

In a further advantageous embodiment of the brake system it is possible to provide that when the service brake system is operationally capable, the wheel brake devices, provided with service brake actuators, of the service brake device are also switched over into their brake state in addition to the emergency brake actuators when the emergency braking operation is triggered. The deceleration can be improved further by this means in order to bring about the shortest possible braking distance.

An exemplary embodiment of the brake system according to the invention will be explained in more detail below. In the drawing:

### BRIEF DESCRIPTION OF THE DRAWINGS

FIG. 1 shows a block circuit diagram of a first exemplary embodiment of the emergency braking device,

FIG. 2 shows a circuit diagram representation of a circuit arrangement of the first exemplary embodiment of the emergency braking device according to Fig. 1,

FIG. 3 shows a schematic, circuit-diagram-like representation of the pneumatic part of the first exemplary embodiment of the emergency braking device,

FIG. 4 shows a schematic representation of a vehicle in a plan view, the arrangement of the emergency brake operator control elements which can be activated manually and of a warning lamp for issuing a warning signal being shown,

FIG. 5 shows a circuit diagram representation of the electrical part of a second exemplary embodiment of the emergency braking device,

FIG. 6 shows a circuit diagram representation of the electrical part of a third exemplary embodiment of the emergency braking device,

FIG. 7 shows a schematic circuit-diagram-like representation of the pneumatic part of the third exemplary embodiment of the emergency braking device,

FIG. 8 shows a circuit diagram representation of the electrical part of a fourth exemplary embodiment of the emergency braking device, and

FIG. 9 shows a schematic, circuit-diagram-like representation of the pneumatic part of the fourth exemplary embodiment of the emergency braking device.

### DETAILED DESCRIPTION OF THE PREFERRED EMBODIMENTS

The invention relates to a brake system for a vehicle 3, in particular utility vehicle, which is embodied by way of example as an electro-pneumatic brake system. Alternatively, the brake system may also be implemented in the form of an electro-mechanical or electro-hydraulic brake system. It is also possible to select a single-circuit or a dual-circuit embodiment of the brake system.

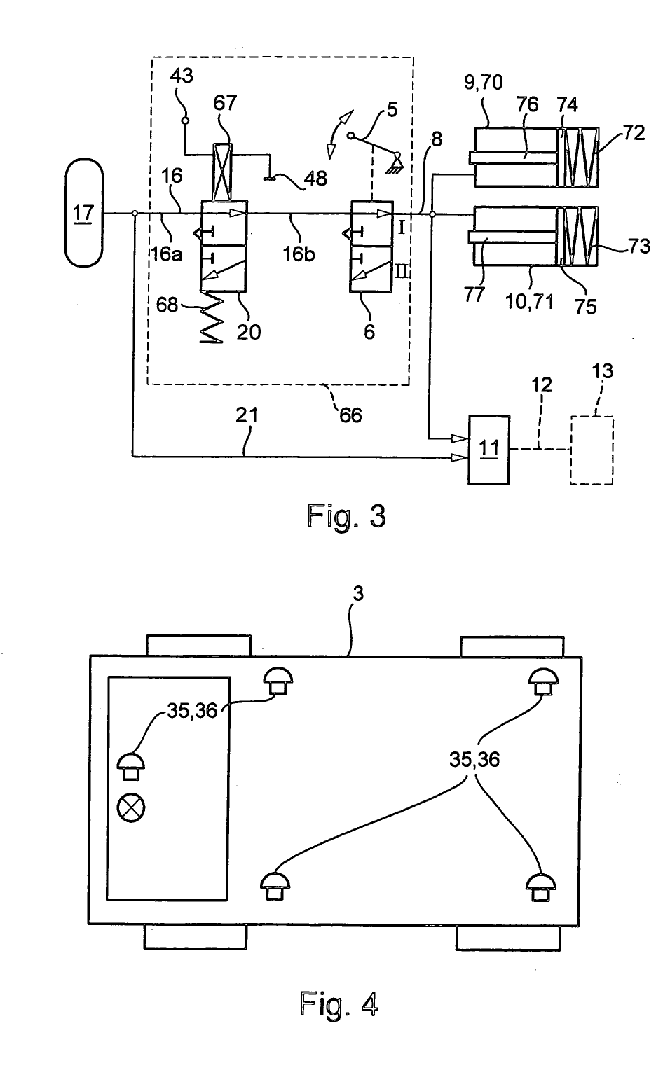

The electro-pneumatic brake system has a service brake device and a parking brake device whose embodiments are known per se. The essential components of a parking brake device for a utility vehicle are illustrated in FIG. 3, which shows the essential elements of the pneumatic part of a first exemplary embodiment of an emergency braking device 28. A parking brake operator control element 5 which can be activated manually, is arranged in the region of the driver's seat of the vehicle 3 and can be moved between a driving position and a braking position, controls or activates a parking brake control valve 6 in such a way that said valve can be switched over between a first switched position I and a second switched position II.

The parking brake control valve 6 is embodied as a 3/2 way valve and is connected fluidically via an outlet line 8 to parking brake actuators 9, 10 of the parking brake device and to a trailer control valve 11 of a coupling device. Of the coupling device, which is used to couple a trailer or semitrailer to the vehicle 3 and is known per se, only the trailer control valve 11 is shown, said valve being in turn fluidically connected, when the connection is brought about, to a trailer or semitrailer via a trailer control line 12 with a trailer braking device 13 of the trailer or semitrailer.

In the first switched position I of the parking brake control valve 6, the outlet line 8 is connected via a first supply line 16 to a first reservoir vessel 17 which is assigned to the parking brake device of the vehicle and in which a pressurized brake fluid, for example compressed air, is located. In the second switched position II, the first supply line 16 is closed off fluidically and at the same time the outlet line 8 is connected fluidically to the surroundings.

As is known, the pressure of the compressed air in the first reservoir vessel 17 is kept within a predefinable pressure range by means of a compressor (not illustrated).

A switchover valve 20 which can be switched over electrically and whose function will be explained in more detail later is connected into the first supply line 16, between the first reservoir vessel 17 and the parking brake control valve 6.

A second supply line 21 connects the reservoir vessel and the trailer control valve 11 and has the purpose of supplying the trailer brake device 13 with compressed air.

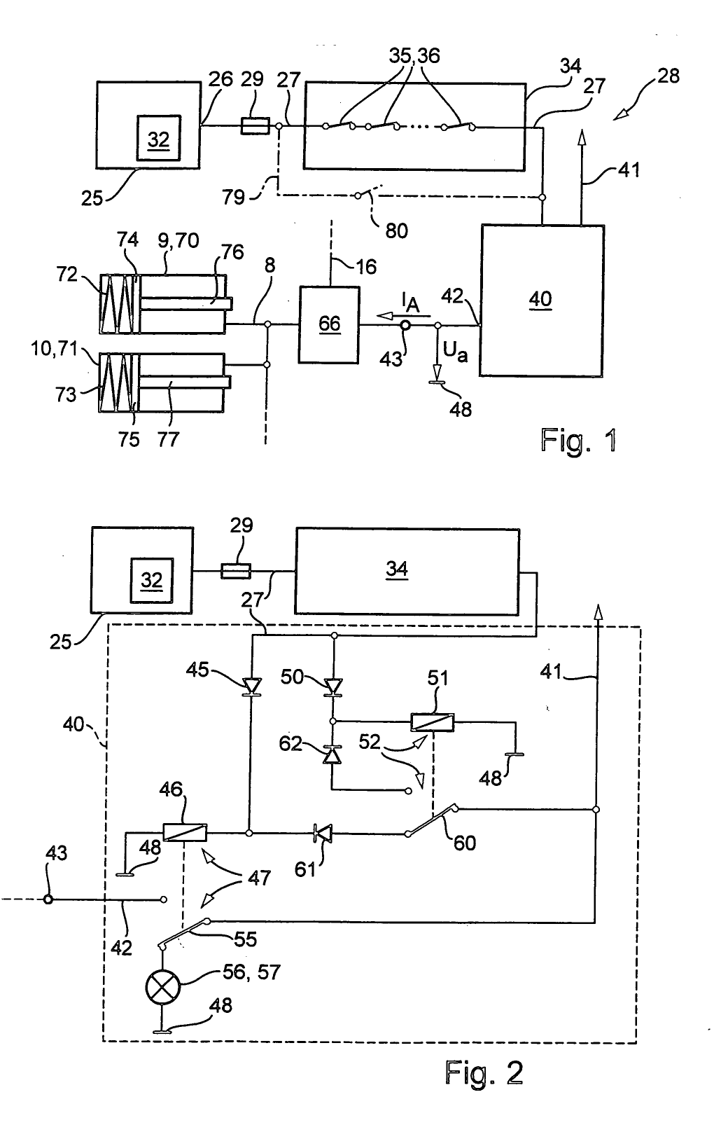

FIG. 1 shows a brake controller 25 whose status output 26 is connected via an electrical status line 27 to a first exemplary embodiment of an emergency braking device 28, provided for carrying out an emergency braking operation, of the brake system. A first fusible element 29 is inserted into the electrical status line 27 as an overload protection for the brake controller.

The brake controller 25 is a component of the electro-pneumatic brake system. Electro-pneumatic brake systems are known from the prior art and are therefore not described in more detail at this point.

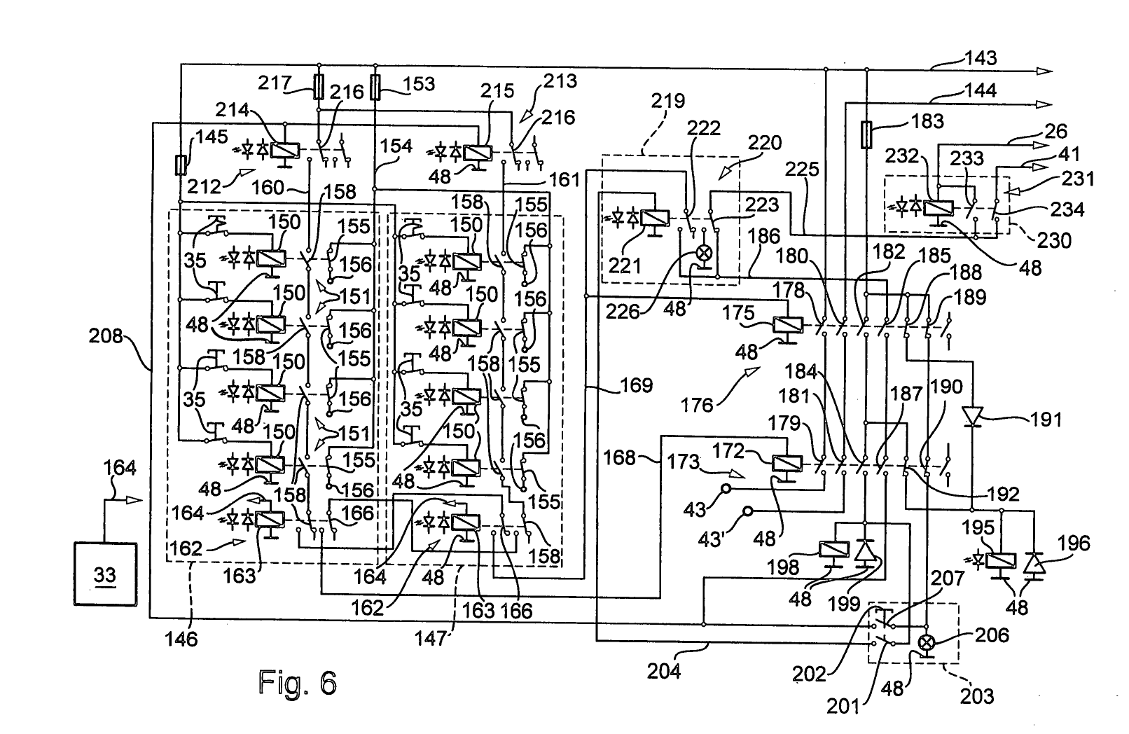

For example, the brake controller 25 has a service brake monitoring device 32 which monitors the service brake continuously or cyclically for defects. The service brake monitoring device 32 may alternatively or additionally be a component of a superordinate monitoring device 33, which is explained in more detail in conjunction with the embodiment shown in FIG. 6. A status voltage, whose absolute value is higher than zero, for example +24 V or +42 V, is present at the status output 26 if the service brake monitoring device 32 has detected the operational capability of the service brake. When a defect is detected in the service brake device, in particular in its operational capability, no status voltage is present at the status output 26, or the value of the status voltage has approximately the value zero volts.

As is apparent in FIG. 1, the emergency braking device 28 has an emergency brake operator control device 34 which serves the purpose of manually triggering an emergency braking operation. The emergency brake operator control device 34 is inserted into the status line 27 and is connected in series with the first fusible element 29. In the preferred exemplary embodiment, it has a series circuit of a plurality of emergency brake operator control elements 35 which may be embodied, for example, as emergency buttons 36. These emergency buttons 36 are implemented in the form of electrical NC (Normally Closed) switches which in their unactivated state respectively connect their two electrical connecting contacts in an electrically conductive fashion so that the status line 27 is not interrupted electrically by the emergency brake operator control device provided all the emergency buttons 36 are in the unactivated state. As soon as only one emergency button 36 has been activated, the switch of the respective emergency button and the status line 27 is interrupted electrically.

The design of the emergency buttons can be selected as desired. FIG. 4 illustrates them schematically in a mushroom-like embodiment. The emergency buttons 36 are arranged at various locations on the vehicle 3. The arrangement should be selected in such a way that at least some of the emergency buttons 36 can easily be reached even from the outside by an operator standing next to the vehicle 3, in order to be able to trigger an emergency braking operation in an emergency situation when the vehicle 3 is in the driverless operating mode. The number of emergency buttons can be selected as desired and depends in particular on the size and the design of the vehicle 3.

An actuable switch arrangement 40 of the emergency braking device 28 is electrically connected to the status line 27. Furthermore, the switch arrangement 40 is connected to a supply voltage source via a supply voltage line 41. It has an output 42 whose electrical signal can be tapped at an output terminal 43. The switched state of the electrical switch arrangement 40 can be changed by means of the status voltage or by means of the status current which is fed to the switch arrangement 40 via the status line 27. The available electrical output current I_{A} or the available electrical output voltage U_{A} at the output 42, and thus at the output terminal 43, also depends on the switched state of the switch arrangement 40.

One embodiment of the switch arrangement 40 of the first exemplary embodiment of the emergency braking device 28 is illustrated in FIG. 2. A first diode 45 is connected to the status line 27, in series with the emergency brake activation device 34 to which is in turn connected in series with a first switching coil 46 of a first switching relay 47, the first switching coil 46 being connected to the vehicle frame 48. A second diode 50 and a second switching coil 51 of a second switching relay 52 are connected in a series circuit with the vehicle frame 48, in parallel with the first diode 45 and the first switching coil 46. The first and second diodes 45, 50 are directed in such a way that a current from the emergency brake activation device 34 can flow to the vehicle frame 48 via the diodes 45, 50 and the first and second switching coils 46 and 51.

A first switch 55, controlled by the first switching coil 46, of the first switching relay 47 connects a warning device 56, for example a warning lamp 57, to the voltage supply line 41, and thus to the supply voltage source, when the first switching coil 46 is not energized. The warning lamp 57 is connected at its other terminal to the vehicle frame so that when the first controlled switch 55 is in the position of rest the warning lamp 57 lights up.

Of course, as an alternative to, or in addition to, the warning lamp 57 it is also possible to use any desired other warning device with which an audible and/or visual warning signal can be generated.

When the first switching coil is energized, the first controlled switch 55 connects the output terminal 43 to the voltage supply line 41.

A second switch 60, controlled by the second switching coil 51, of the second switching relay 52 connects the supply voltage line 41 via a third diode 61 to the first switching relay 46, and thus simultaneously to the first diode 45, when the second switching coil 51 is not energized, and owing to the orientation of the third diode 61 a flow of current is possible from the supply voltage line 41 to the vehicle frame 48 via the second switch 60, the third diode 61 and the first switching coil 46.

When the second switching coil 51 is energized, the second switch 60 brings about a series circuit of the voltage supply line 41, the second switch 60, a fourth diode 62, the second switching coil 51 and the vehicle frame 48, a flow of current from the supply voltage line 41 to the vehicle frame being possible owing to orientation of the fourth diode 62.

A switchover device 66 of the emergency braking device 28 is connected to the output terminal 43. It can be switched over between a plurality of states as a function of the output current I_{A} and the output voltage U_{A} at the output terminal 43.

The switchover device 66 has the switchover valve 20 and may also be formed exclusively by the switchover valve 20. According to FIG. 3, the switchover device 66 also contains the parking brake operator control element 5 and the parking brake control valve 6. The switchover valve 20 has a first electromagnet 67 which is used for switching over and which is connected on the one hand to the vehicle frame and on the other hand to the output terminal 43. The switchover valve 20 is mechanically prestressed, for example by means of a spring 68, into a position of rest so that when the first electromagnet 67 is not energized said valve 20 assumes this position of rest. By energizing the first electromagnet 67 it is possible to switch over the switchover valve 20 from its position of rest into an operating position which is shown in FIG. 3. In the operating position, the switchover valve 20 enables the first supply line 16 and connects the first reservoir vessel 17 to the parking brake control valve 6. In the position of rest, the section 16a, connected to the first reservoir vessel 17, of the first supply line 16 is blocked fluidically and at the same time the section 16b, connected to the parking brake control valve 6, of the first supply line 16 is connected fluidically to the surroundings.

In the preferred exemplary embodiment, the parking brake actuators 9, 10 serve simultaneously as emergency brake actuators 70, 71 which, when an emergency braking operation is triggered, switch over into a the assigned wheel brake devices into a braking state so that the respective vehicle wheels are braked. According to FIGS. 1 and 3, two parking brake actuators 9, 10 and emergency brake actuators 70, 71 which can act, for example on the vehicle wheels on the rear axle of the vehicle 3, are provided. Alternatively to this, not only the wheel brake devices of one axle of the vehicle but also those of a plurality of axles or of all the axles of the vehicle 3 could have emergency brake actuators.

The emergency brake actuators 70, 71 are formed in the present case by spring brake cylinders whose pistons 74, 75, and the piston rods 76, 77 connected thereto are each prestressed, by means of a spring 72 or 73, into a state of rest in which the assigned wheel brake device is in the braking state. By applying pressure to the piston 74 or 75 from the side opposite the spring 72 or 73, the piston can then be displaced counter to the spring force, the assigned wheel brake device being able to be moved into an enabling state which enables the respective wheel.

The method of operation of the emergency braking device 28 is explained below.

Provided that the service brake monitoring device 32 does not detect a defect in the service brake device, a status voltage of, for example +24V or +42V is present at the status output 26. Assuming also that the emergency brake operator control device 34 is not activated, that is to say none of the emergency buttons 36 has been activated, the status voltage is also present on the status line 27. This leads to a situation in which a current flows both through the first switching coil 46 and through the second switching coil 51, so that the respectively assigned controlled first switch 55 and second switch 60 respectively assume their activated switched position (not illustrated in FIG. 2). The output terminal 43 is connected to the supply voltage line 41 via the first switch 55 of the first switching relay 47 so that an output voltage U_{A} which preferably corresponds to the status voltage is also present on said line 41.

The result of this is that the first electromagnet 67 of the switchover valve 20 is energized and the switchover valve assumes its operating position (not shown). Assuming that the parking brake device is not activated by means of the parking brake operator control element 5, so that the parking brake control valve 6 is in its first switched position I and connects the output line 8 to the section 16b of the supply line 16, the emergency brake cylinders 70, 71 which are formed by the parking brake cylinders 9, 10 have compressed air applied to them from the first reservoir vessel 17. The wheel braking devices which have the emergency brake cylinders 70, 71 are then in the enabling state which enables the assigned vehicle wheels.

If the service brake monitoring device 32 has detected a defect in the service brake device, the status voltage at the status output 26 drops to approximately zero volts, which leads to a situation in which a voltage of approximately zero volts is also present on the status line. The activation of one of the emergency buttons 36 (manual triggering of an emergency braking operation) which disconnects the status line 27, also disconnects the switch arrangement 40 from the status output 26 so that a voltage of approximately zero volts is present on the section of the status line 27 assigned to the switch arrangement.

As a result, there is no longer any current flowing through the first switching coil 46, and the first controlled switch 55 assumes the position of rest illustrated in FIG. 2. The warning lamp 57 then lights up and outputs an optical warning signal. There is no output voltage U_{A} at the output terminal 43, or U_{A} has the value of approximately zero volts.

The result of this is that no current (U_{A}=0V) flows through the first electromagnet 67 of the switchover valve 20. The switchover valve 20 is displaced by means of the spring 68 into its position of rest, the section 16a of the first supply line 16 being cut off and the section 16b of the first supply line 16 being connected fluidically to the surroundings. The emergency brake actuators 70, 71 are thus vented via the output line 8, the parking brake control valve 6 and the switchover valve 20, i.e. a pneumatic pressure corresponding approximately to the ambient air pressure is present on the side of the piston 74, 75 which is opposite the spring 72, 73. The springs 72, 73 move the pistons 74, 75 with the piston rods 76, 77, as a result of which the wheel brake devices which have the emergency brake actuators 70, 71 are moved into the braking state so that an emergency braking operation is carried out.

As is apparent from FIG. 3, the triggering of an emergency braking operation with a trailer or semitrailer connected to the vehicle 3 can also additionally trigger, via the trailer control valve 11, the control line 12 and the trailer brake device 13, a braking operation at the trailer wheel brake devices of at least one trailer axle in order to improve the braking effect of the train composed of the vehicle 3 and trailer or semitrailer.

Furthermore, there is the possibility, given an intact service brake device, of supporting the emergency braking operation by virtue of the fact that, in addition to the emergency brake actuators 70, 71, the service brake actuators are also switched over into their respective braking position. This provides an improved braking effect. In addition, the braking force or the brake pressure at the wheel brake devices of the service brake can also be controlled or regulated (antilock brake control, brake force distribution control at front axle/rear axle etc.). This connection of the service brake device into the circuit when an emergency braking operation is triggered may easily be implemented, for example, by virtue of the fact that the output voltage U_{A} and/or the output current I_{A} is transmitted to the brake control device of the electro-pneumatic brake system so that the triggering of an emergency braking operation by manual activation of the emergency brake operator control device 34 can be detected by the brake control device. Of course, it is not possible to support the emergency braking operation using the service brake device if the latter is operationally incapable and the emergency braking operation is triggered automatically by the service brake monitoring device 32.

In the exemplary embodiment, the drive assembly of the vehicle 3, here a drive motor, is simultaneously supplied with voltage via the output terminal 43. As soon as an emergency braking operation occurs and the output voltage drops approximately to zero volts, the drive motor is switched off. During the emergency braking operation, the drive motor then generates, owing to its dragging motor, a brake torque at the driven wheels of the vehicle. Furthermore, a drive torque acting on the driven wheels, which would counteract the emergency braking torque brought about by the emergency braking operation, is avoided.

The entire steering device of the vehicle is also supplied with electrical energy during the emergency braking operation so that it remains completely capable of being used and the steerability of the vehicle 3 is ensured even in an emergency braking operation.

In a further embodiment variant of the brake system, at least the manual triggering of an emergency braking operation can be switched on and off. This has the purpose of making the brake system, and thus the vehicle 3, suitable both for the autonomous, driverless operating mode and for operation with a driver in public road traffic. In the driverless operating mode, for example on journeys within a works site, the possibility of manual intervention must be provided. By virtue of the emergency buttons 36 which are mounted on the vehicle 3 it is possible for a person (for example road user) who is located next to or on the vehicle to trigger the immediate stopping of the vehicle in an emergency by activating one of the emergency buttons 36, for example in order to prevent an accident.

However, when operating with a driver, it is instead necessary to transfer responsibility to the driver and essentially rule out intervention by third parties. Then, the manual triggering of an emergency braking operation can at least be prevented.

As indicated in FIG. 1 by a dot-dashed line, an electrical bypass line 79 with a third switch 80 could be provided in parallel with the emergency brake operator control device 34 for this purpose. With the third switch 80 closed, the emergency brake operator control device 34 would be ineffective, whereas with the third switch 80 opened the emergency brake operator control device 34 would be effective as a triggering device for an emergency braking operation.

The third switch 80 can be activated manually or automatically. For example, it can be activated by means of a driver detection device (not illustrated) which has the purpose of determining whether the vehicle 3 is in the driverless operating mode or is controlled by a driver. The driver detection device can have, for this purpose, for example a driver's seat occupation sensor, or can detect the manual operation of operator control elements such as steering wheel and/or pedals in order to be able to determine a driverless operating mode or a driver-controlled operating mode.

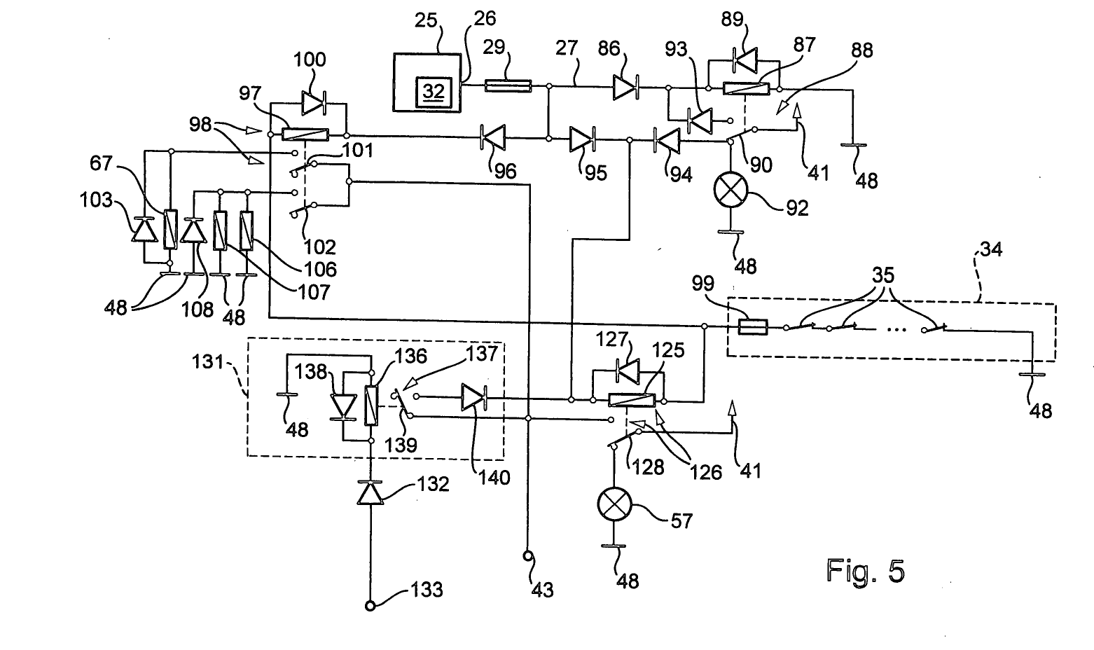

FIG. 5 shows the electrical part of a second exemplary embodiment of the emergency braking device 28 according to the invention. In this second exemplary embodiment, there is additionally provision that when the emergency stop is triggered, the wheel brake devices at the front axle of the vehicle are also activated in order to obtain a braking effect. In FIG. 5, the components of the emergency braking device 28 which are identical to the first exemplary embodiment are provided with the same reference symbols.

The status line 27 is connected to the status output 26 of the brake control device 25, and starting from the status output 26 into the status line 27, the first fusible element 29, a fifth diode and a third switching coil 87 of a third switching relay 88 are connected in series, the third switching coil 87 being connected by its further electrical terminal to the vehicle frame 48. A freewheeling diode 89 is connected in parallel with the third switching coil 87, and in the opposite direction to the fifth diode 86. A controlled fourth switch 90 of the third switching relay 88 is connected between the voltage supply line 41 and a fault lamp 92 whose second electrical contact is connected to the vehicle frame 48, and connects the fault lamp 92 in the currentless state of the third switching coil 87 to the voltage supply line 41. In the energized state of the third switching coil 87, the controlled fourth switch 90 connects the voltage supply line 41 to a sixth diode 93 at the anode end, the sixth diode 93 being connected at the cathode end to the cathodes of the fifth diode 86 and of the freewheeling diode 89 and of the third switching coil 87. This leads to a situation in which the third switching relay 88 excites itself as it were, since the controlled fourth switch 90 maintains a flow of current through the third switching coil 87 as soon as the third switching coil 87 of the third switching relay 88 has been attracted and the supply voltage is maintained across the voltage supply line 41. If no status voltage is present at the status output 26 of the brake control device after the ignition has been switched on, the fault lamp 92 lights up and indicates a defect in the brake device of the vehicle.

The following series circuit is provided in parallel with the fault lamp 92: a sixth diode 94, a seventh diode 95, an eighth diode 96, a fourth switching coil 97 of a fourth switching relay 98 and the emergency brake operator control device 34. In contrast to the first exemplary embodiment, a second fusible element 99 is connected in series with the emergency brake operator control elements 35 of the emergency brake operator control device 34. The arrangement of the three diodes 94, 95, 96 is such that the anode of the sixth diode 94 is connected to the fault lamp 92. The cathode of the sixth diode 94 is then connected to the cathode of the seventh diode 95, the anode of the seventh diode 95 is connected to the anode of the eighth diode 96 and the cathode of eighth diode 96 is then connected to the fourth switching coil 97 of the fourth switching relay 98. A freewheeling diode 100, whose cathode is connected to the cathode of the eighth diode 96, is provided in parallel with the fourth switching coil 97.

The fourth switching relay 98 has a controlled fifth switch 101 and a controlled sixth switch 102 which are coupled to one another. At the input end, the two switches 101, 102 are electrically connected to one another and to the output terminal 43. At the output end, the one fifth switch 101 is connected to the first electromagnet 67 of the switchover valve 20. In a modification with respect to the exemplary embodiment according to FIG. 3, the first electromagnet 67 is therefore not connected directly to the output terminal 43. The first electromagnet 67 is actuated here by the fourth switching relay 98. In the embodiment according to FIG. 5, a freewheeling diode 103, whose cathode is connected at the output end to the fifth switch 101 of the fourth switching relay 98, is connected in parallel with the first electromagnet 67. The first electromagnet 67 is connected by its further electrical terminal to the vehicle frame 48.

The other controlled sixth switch 102 of the fourth switching relay 98 is connected at the output end to a parallel circuit composed of a second electromagnet 106, a third electromagnet 107 and a freewheeling diode 108, the parallel circuit being connected at the other end to the vehicle frame 48.

The two electromagnets 106, 107 are provided for actuating the wheel brake devices of the service brake system of the vehicle in order to bring about an emergency braking force there. The actuation can take place in accordance with the actuation at the front and rear axles of the vehicle, which is explained in conjunction with the third and fourth exemplary embodiments. Alternatively, one of the electromagnets 106, 107 can be dispensed with and the remaining electromagnet can be used to actuate only the wheel brake devices of the service brake on one vehicle axle for the purpose of emergency braking.

FIG. 5 also shows that the terminal of the emergency brake operator control device 34 which is connected to the fourth switching coil 97 of the fourth switching relay 98 is electrically connected to a fifth switching coil 125 of a fifth switching relay 126. The other electrical terminal of the fifth switching coil 125 is connected to the cathodes of the sixth and seventh diodes 94, 95 and at same time to the cathode of a freewheeling diode 127 which is provided in parallel with the fifth switching coil 125.

A seventh switch 128 of the fifth switching relay 126 is connected at the input end to the voltage supply line 41. When the fifth switching coil 125 is not energized, the controlled seventh switch 128 connects the voltage supply line 41 to the warning lamp 57, which is connected by its other electrical terminal to the vehicle frame 48. When the fifth switching coil 125 is energized, that is to say when the fifth switching relay 126 attracts, the seventh switch 128 connects the voltage supply line 41 to the output terminal 43.

In the embodiment shown in FIG. 5, a starter bypass 131 is also provided, said bypass 131 having the purpose of preventing the fifth switching relay 126 from dropping out when the motor starts. Since the status voltage decreases severely for a brief time when the engine starts, and this decrease would result in the fifth switching relay 126 dropping out, and the emergency braking operation thus being triggered, the fifth switching relay 125 is energized by means of the starter bypass 131 during the starting operation of the engine so that the fifth switching relay 126 is prevented from dropping out.

The starter bypass 131 is connected via a ninth diode 132 to the ignition terminal 133. When the engine starts, an ignition voltage, which corresponds essentially to the voltage supply of the vehicle such as is also present at the voltage supply line 41, is connected to the ignition terminal 133. The ninth diode 132 is connected here at the anode end to the ignition terminal 133. The cathode of this diode 132 is connected to a sixth switching coil 136 of a sixth switching relay 137, the other electrical terminal of the sixth switching coil 136 being connected to the vehicle frame 48. A freewheeling diode 138, whose anode is also connected to the vehicle frame 48, is connected in parallel with the sixth switching 136.

A controlled, eighth switch 139 of the sixth switching relay 136 is connected at the input end to the output terminal 43 and in the energized state of the sixth switching coil 136 said switch 139 brings about an electrical connection between the output terminal 43 and the anode of a tenth diode 140 of the starter bypass 131. At the cathode end, the tenth diode 140 of the starter bypass 131 is connected to the fifth switching coil 125 of the fifth switching relay 126 and at the same time is connected to the cathodes of the sixth and seventh diodes 94, 95 and of the freewheeling diode 127 which is assigned to the fifth switching relay 126. The fifth switching coil 125 of the fifth switching relay 126 is therefore connected between the emergency brake operator control device 34 and the cathode of the tenth diode 140 of the starter bypass 131.

The method of operation of the electrical part of the second exemplary embodiment of the emergency braking device 28 is as follows:

If a defect is detected in the service brake device when the ignition is switched on a status voltage at the level of approximately zero volts is present at the status output 26 of the brake control device 25. No current therefore flows through the third switching coil 87 of the third switching relay 88 so that the controlled fourth switch 90 of the third switching relay 88 is in the switched position shown in FIG. 5, the fault lamp 92 being connected on the one hand to the vehicle frame 48 and on the other hand to the supply voltage line 41 via the fourth switch 90 so that the fault lamp 92 lights up and indicates a fault in the service brake device.

If the service brake device is operationally capable, the third switching coil 87 of the third switching relay 88 is energized owing to the positive status voltage which is present at the status output 26, as a result of which the fourth switch 90 of the third switching relay 88 is attracted and connects the supply voltage line 41 to the sixth diode 93. The third switching coil 87 is energized by the series connection of the voltage supply line 41, sixth diode 93, third switching coil 87 and vehicle frame 48 for as long as a supply voltage is present on the supply voltage line 41 and the fault lamp 92 does not light up.

Owing to the status voltage present at the status output 26 in the operationally capable state of the service brake device, the fourth switching relay 98 also attracts so that the electrical connection between the output terminal 43 and the first electromagnet 67 of the switchover valve 20 is brought about. The switchover valve 20 is therefore in its switched position shown in FIG. 3, and brings about a fluidic connection between the line sections 16a and 16b of the first supply line 16. When the parking brake device is not activated, pressure is applied to the two emergency brake actuators 70, 71 and they release the assigned wheels. The sixth switch 102 of the fourth switching relay 98 connects the electromagnets 106, 107 in order to actuate the wheel brake devices of the service brake device with the output terminal 43.

Owing to the positive potential at the status output 26 (for example +24 or +42 volts), a current also flows across the first fusible element 29, the seventh diode 95, the fifth switching coil 125 and the emergency brake operator control device 34 to the vehicle frame 48, provided that an emergency stop has not been triggered by means of the emergency brake operator control device 34. As a result, the fifth switching relay 126 attracts and the controlled seventh switch 128 of the fifth switching relay 126 connects the supply voltage line 41 directly to the output terminal 43 so that the potential at the output terminal 43 corresponds to that of the supply voltage line 41, in particular +24 volts or +42 volts.

As described above, the two electromagnets 106, 107 are connected on the one hand to the vehicle frame 48 and on the other hand via the sixth switch 102 of the fourth switching relay 98 to the output terminal 43 whose potential corresponds to that of the voltage supply line 41. For this reason a current, which causes no emergency braking effect to be brought about at the respectively assigned wheel brake devices 116, 117, flows through the two electromagnets 106, 107.

When the engine starts, the voltage at the status output 26 of the brake controller 25 dips, which causes the fifth switching relay 126 to drop out, and would thus lead to triggering of the emergency braking operation. For this reason, when the engine is started, a positive voltage is applied to the ignition terminal 133 directly via the ignition of the vehicle, so that, by means of the eighth switch 139, the sixth switching relay 137 brings about an electrical connection between the voltage supply line 41 and the fifth switching coil 125 so that a current can flow from the voltage supply line 41 via the eighth switch 139, the fifth switching coil 125 and the emergency operator control device 34 to the vehicle frame 48, and said current keeps the fifth switching relay 126 in its attracted position in order to prevent triggering of the emergency braking operation. When the starting process of the engine has finished, the status voltage at the status output 26 of the brake controller 25 assumes its normal value again and the voltage at the ignition terminal 133 drops off again. For this reason, the sixth switching relay 137 goes back in to the switched position illustrated in FIG. 5 so that no current flows through the fifth switching coil 125 via the tenth diode 140 of the starter bypass 131.

If an emergency braking operation is then triggered by means of the emergency brake operator control device 34, the fifth switching coil 125 is not energized and the controlled seventh switch 128 connects the voltage supply line 41 via the warning lamp 57 to the vehicle frame 48 so that the warning lamp 57 indicates a triggered emergency braking operation.

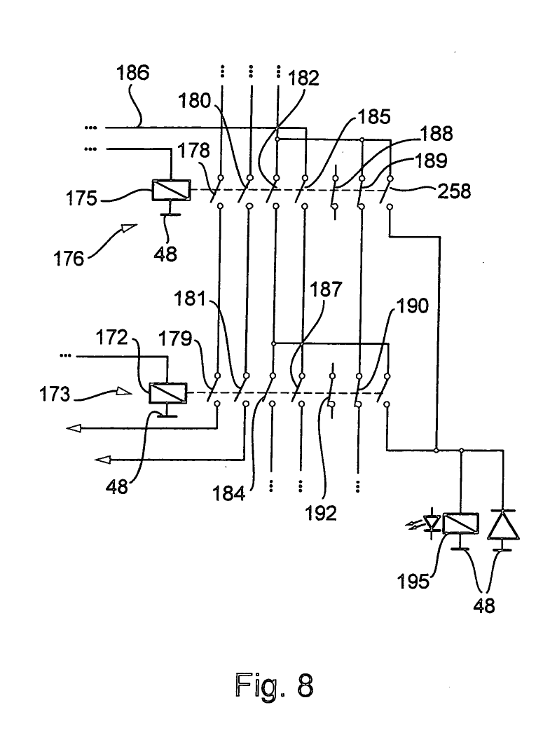

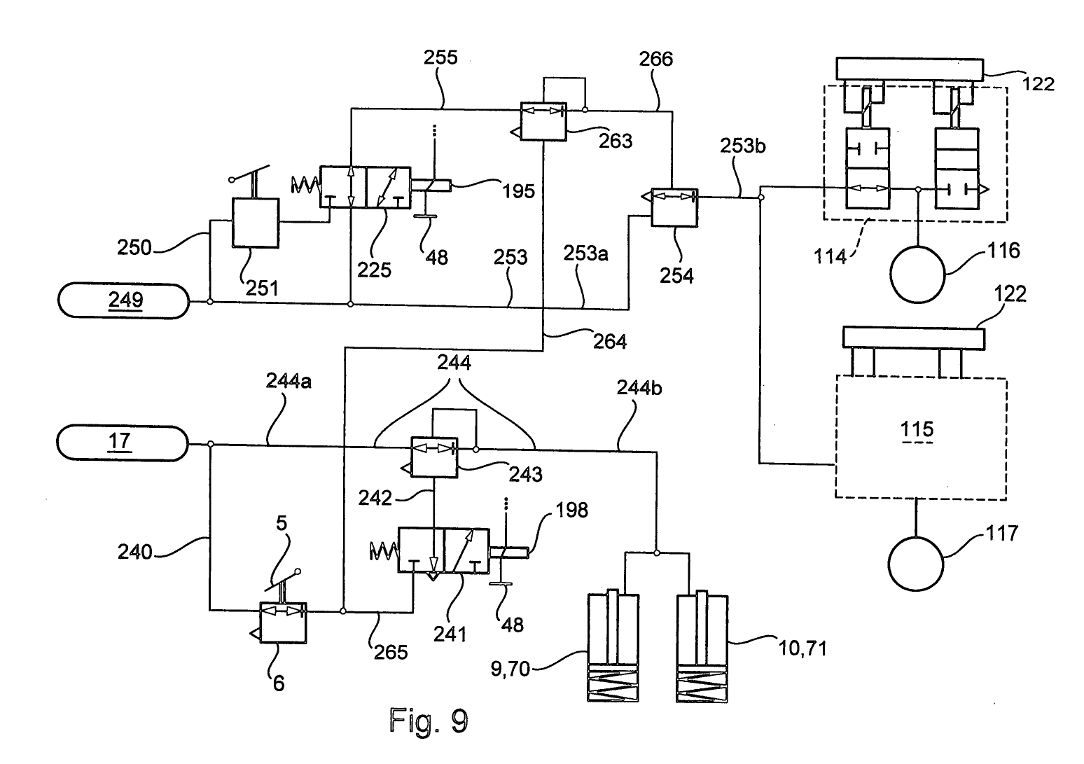

It is also the case that current can no longer flow through the fourth switching coil 97 of the fourth switching relay 98 from the status output 26 to the vehicle frame 48 owing to the line which is interrupted in the emergency brake operator control device 34, so that the controlled fifth and sixth switches 101 and 102 of the fourth switching relay 98 respectively drop out into their position shown in FIG. 5 and disconnect the connections from the output terminal 43 to the electromagnets 67, 106 and 107. Owing to the first electromagnet 67 which is not energized, the emergency brake actuators 70, 71 which are embodied as stored-energy spring cylinders are vented to the atmosphere via the line section 16b and the output line 8 so that they assume their emergency braking position which brakes the assigned wheels. At the same time, no current flows any more through the second and third electromagnets 106, 107, as a result of which the respective wheel brake devices act on the assigned wheels in a braking fashion, which will be explained in more detail later with reference to FIGS. 8 and 9.

FIG. 6 shows the electrical part of a third exemplary embodiment of the emergency braking device 28. In the preferred embodiment illustrated in FIG. 6, a first ignition voltage supply line 143 and a second ignition voltage supply line 144 are provided, a positive supply voltage of, for example, +24 volts or +42 volts being then present on said lines when the ignition of the vehicle is switched on. The two ignition voltage supply lines 143, 144 may be connected to different terminals of the ignition.

A first triggering arrangement 146 and a second triggering arrangement 147 of the emergency brake operator control device 34 are connected in parallel with one another to the first ignition supply voltage line 143 via a third fusible element 145. Both the first and second triggering arrangements 146 and 147 each have four series circuits, in each of which an emergency brake operator control element 34 is connected in series with a seventh switching coil 150 of an emergency brake switching relay 151, the seventh switching coil 150 being connected by its further electrical terminal to the vehicle frame 48. The emergency brake operator control elements 35 are embodied as what are referred to as normally closed switches and in their nonactivated state they connect the respectively assigned seventh switching coil 150 of the respective emergency brake switching relay 151 to the first ignition voltage supply line 153. Via a fourth fusible element 153, a monitoring line 154 is connected to the first ignition voltage supply line 143 and is led both to the first and to the second triggering arrangement 146 and 147. The monitoring line 154 is connected in each case to a terminal of a monitoring switch 155 of each emergency brake switching relay 151. The monitoring switch 155 is embodied, for example, as an NC switch and therefore brings about an electrical connection between the monitoring line 154 and a monitoring terminal 156 when the seventh switching coil 150 of the emergency brake switching relay 151 is not energized. This monitoring terminal 156 serves the purpose of interrogating the status of the emergency brake switching relay 151. If approximately the potential of the first ignition voltage supply line 143 is present on the monitoring terminal 156, the assigned switching relay 151 is not activated, i.e. no current flows through the respective seventh switching coil 150. When the seventh switching coil 150 is energized, the monitoring switch 155 is opened so that a voltage of approximately zero volts is present on the monitoring terminal 156.

The emergency brake switching relays 151 have not only the monitoring switch 155 but also one emergency brake switch 158 each. The emergency brake switches 158 of the emergency brake switching relays 151 of the first triggering arrangement 146 and of the second triggering arrangement 147 are each connected in series. The series circuit of the emergency brake switches 158 of the first triggering arrangement 146 is connected at the input end to a first reset output line 160. Correspondingly, the series circuit of the emergency brake switches 158 of the second triggering arrangement 147 is connected at the input end to a second reset output line 161.

The two triggering arrangements 146, 147 also each have an externally actuable emergency brake switching relay 162 whose eighth switching coil 163 is connected on the one hand to the vehicle frame 48 and on the other hand to a signal line 164. The signal line 164 may lead, for example, to a monitoring device 33 which actuates the eighth switching coils 163 of the externally actuable emergency brake switching relays 162 in order to trigger the emergency braking operation. Such an externally triggered emergency braking operation may take place, for example, in the driverless operating mode of the vehicle when the vehicle 3 leaves a predefined driving lane. Here, a navigation system of the monitoring device 33 can be used to signal, by means of a monitoring signal, whether the vehicle 3 is in the predefined driving corridor or has left it. The monitoring device 33 correspondingly actuates the externally actuable emergency brake switching relays 162 as a function of the monitoring signal. Alternatively, or in addition, the externally actuable emergency brake switching relays 162 can be actuated directly or indirectly by means of the monitoring device 33, via a manually triggerable radio signal, in order to trigger an emergency braking operation under remote control by radio in emergency situations.

The externally actuable emergency brake switching relays 162 each have, as do the emergency brake switching relays 151, an emergency brake switch 158 which is connected in series with the respective other emergency brake switches 158 of the respective triggering arrangement 146 or 147. The externally actuable emergency brake switching relays 162 each have an additional switch 166. The emergency brake switch 158 of the externally actuable emergency brake switching relay 162 of the first triggering arrangement 146 is connected by its output-end electrical terminal to the input-end electrical terminal of the additional switch 166 of the externally actuable emergency brake switching relay 162 of the second triggering arrangement 147. Correspondingly, the emergency brake switch 158 of the externally actuable emergency brake switching relay 162 of the second triggering arrangement 147 is connected by its output-end electrical terminal to the input-end electrical terminal of the additional switch 166 of the externally actuable emergency brake switching relay 162 of the first triggering arrangement 146. As a result, the emergency brake switch 158 of the one externally actuable emergency brake switching relay 162 is connected in series with the additional switch 166 of the respective other externally actuable emergency brake switching relay 162.

The additional switch 166 of the externally actuable emergency brake switching relay 162 of the first triggering arrangement 146 is connected to a first isolation actuating line 168. The additional switch 166 of the externally actuable emergency brake switching relay 162 of the second triggering arrangement 147 is connected at the output end to a second isolation actuating line 169.

The first isolation actuating line 168 is connected to a ninth switching coil 172 of a first isolating relay 173, the ninth switching coil 172 being connected the its further electrical terminal to the vehicle frame 48. Analogously to this, the second isolation actuating line 169 is connected to a tenth switching coil 175 of a second isolating relay 176, the tenth switching coil 175 being connected by its further electrical terminal to the vehicle frame 48.

The two isolating relays 173, 176 are, for example, of identical design. According to FIG. 6, both isolating relays 163, 176 each have seven isolating switches.

The first isolating switch 178 of the second isolating relay 176 is connected on the one hand to the first ignition voltage supply line 143 and on the other hand to the first isolating switch 179 of the first isolating relay 173. The second isolating switch 180 of the second isolating relay 176 is connected on the one hand to the second ignition voltage supply line 144 and on the other hand to the second isolating switch 181 of the first isolating relay 173. The third isolating switch 182 of the second isolating relay 176 is connected on the one hand to the first ignition voltage supply line 143 via a fifth fusible element 183, and on the other hand to the third isolating switch 184 of the first isolating relay 173. The fourth isolating switch 185 of the second isolating relay 176 is connected on the one hand to a bypass output line 186 and on the other hand to the fourth isolating switch of the first isolating relay 173. The fifth isolating switch 188 of the second isolating relay 176, and the sixth isolating switch 189 of the second isolating relay 187 are connected to one another at the input end and to the input end of the third isolating switch 182 of the second isolating relay 176. In this way, both the third isolating switch 182 and the fifth isolating switch 188 and sixth isolating switch 189 are electrically connected at the input end to the first ignition voltage supply line 143 via the fifth fusible element 183. The sixth isolating switch 189 of the second isolating relay 176 is connected at the output end to the sixth isolating switch 190 of the first isolating relay 173. The fifth isolating switch 188 of the second isolating relay 176 is connected at the output end via an eleventh diode 199 to the output end of the fifth isolating switch 192 of the first isolating relay 173, the anode of the diode 191 being assigned to the output end of the fifth isolating switch 188 of the second isolating relay 176.

A fourth electromagnet 195, which is connected by its other electrical terminal to the vehicle frame 48, is connected to the cathode of the diode 191. A freewheeling diode 196 is connected in parallel with the fourth electromagnet 195.

The respective seventh switch of the isolating relays 173 and 176 is unused in this exemplary embodiment, and in a modified embodiment could be used to control or display the switched state of the isolating relay 173 or 176, as is carried out by means of the monitoring switch 155 in the case of the emergency switching relays 151.

The first isolating switch 179 of the first isolating relay 173 is connected at the output end to the output terminal 43. The output terminal 43 is used to supply voltage to various vehicle assemblies, in particular the drive engine. At the output end, the second isolating switch 181 of the first isolating relay 173 is connected to an output terminal 43′ which can be used, like the output terminal 43, to supply voltage to vehicle assemblies.

The fifth isolating switches 188, 192 and the sixth isolating switches 189, 190 are embodied as normally closed (NC) switches, while all the other isolating switches are embodied as normally open (NO) switches, and they assume their respective open position when the ninth or tenth switching coil 172, 175 is not energized.

The third isolating switch 184 of the first isolating relay 173 is connected at the output end to a fifth electromagnet 198 which is connected by its other electrical terminal to the vehicle frame 48. A freewheeling diode 199 is connected in parallel with the fifth electromagnet 198. Furthermore, the third isolating switch 184 of the first isolating relay 173 is connected at the input end to the input of the fifth isolating switch 192 of the first isolating relay 173, and to the output of the third isolating switch 182 of the second isolating relay 176. The third isolating switch 184 of the first isolating relay 173 is connected by its output to a first reset switch 201 of a reset button 202 of a reset device 203. The other electrical terminal of the first reset switch 201 of the reset button 202 is connected to a first reset actuation line 204 so that when the reset button 202 is activated an electrical connection is brought about between the first reset actuation line 204 and the output end of the third isolating switch 184 of the first isolating relay 173.

At the output end, the sixth isolating switch 190 of the first isolating relay 173 is connected to a reset display lamp 206 whose other electrical terminal is connected to the vehicle frame 48. The reset display lamp 206 is a component of the reset device 203.

Furthermore, the output of the sixth isolating switch 190 of the first isolating relay 173 is connected to a second reset switch 207 of the reset button 202, the other electrical terminal of the second switch 207 being connected to a second reset actuation line 208. When the reset button 202 is activated, an electrical connection is accordingly brought about between the second reset actuation line 208 and the output end of the sixth isolating switch 190 of the first isolating relay 173.

The second reset actuation line 208 actuates a first reset relay 212 and a second a reset relay 213. The eleventh switching coil 214 of the first reset relay 212, and the twelfth switching coil 215 of the second reset relay 213 are connected, in parallel with one another, on the one hand to the second reset actuation line 208 and on the other hand to the vehicle frame 48. The reset relays 212 and 213 each have a controlled ninth switch 216 which is connected at the input end via a sixth fusible element 217 to the first ignition voltage supply line 143. At the output end, the controlled ninth switch of the first reset relay 212 is connected to the first reset output line 160. The controlled ninth switch 216 of the second reset relay 213 is connected at the output end to the second reset output line 161. The two reset relays 212, 213 have a controlled switch, not used for example, which could be used, in a modification of the embodiment illustrated in FIG. 6, as a monitoring switch for monitoring the switched state of the respective relay, as is implemented in the emergency brake switching relay 151 by means of the monitoring switch 155.

The first reset actuation line 204 is connected to a run-up bypass 219 which, in the third exemplary embodiment of the emergency braking device 28 according to FIG. 6, has a bypass switching relay 220 whose thirteenth switching coil 221 is connected on the one hand to the first reset actuation line 204 and on the other hand to the vehicle frame 48. A controlled first bypass switch 222 of the bypass relay 220 connects, when the thirteenth switching coil 221 is energized, the second isolating actuating line 169 to the bypass output line 186 and isolates this connection when the thirteenth switching coil 221 is not energized. A controlled second bypass switch 223 of the bypass relay 220 connects an engine starter bypass line 225 to the bypass output line 186 when the thirteenth switching coil 221 is not energized. When the thirteenth switching coil 221 of the bypass relay 220 is energized, the second bypass switch 223 connects the engine starter bypass line 225 to a bypass display lamp 226 which is connected by its other electrical terminal to the vehicle frame 48.

In the exemplary embodiment according to FIG. 6, an engine starter bypass 230 is provided whose function corresponds to the starter bypass 131 of the embodiment shown in FIG. 5. The engine starter bypass 230 has an engine starter bypass relay 231 and is formed, for example, by this engine starter bypass relay 231. The fourteenth switching coil 232 of the engine starter bypass relay 231 is connected by its one electrical terminal to the status output 26 of the braking controller 25 and is connected at the other end to the vehicle frame 48. A controlled tenth switch 233 of the engine starter bypass relay 231 connects, in the energized state of the fourteenth switching coil 232, the status output 26 to the engine starter bypass line 225 and disconnects this connection when the fourteenth switching coil 232 of the engine starter bypass relay 231 is not energized. A controlled eleventh switch 234 of the engine starter bypass relay 231 connects the voltage supply line 41 to the engine starter bypass line 225 in the nonenergized state of the fourteenth switching coil 232, and disconnects this connection when the fourteenth switching coil 232 of the engine starter bypass relay 231 is energized.

It is to be noted that freewheeling diodes can be provided in parallel with the switching coils of the relays even if this has not been expressly mentioned. Furthermore, it is also possible to arrange in parallel with the switching coils or relays light emitting diodes which supply a visual output signal for indicating the switched state of the assigned relay. This is indicated, for example, for the emergency brake switching relays 151 in FIG. 6.

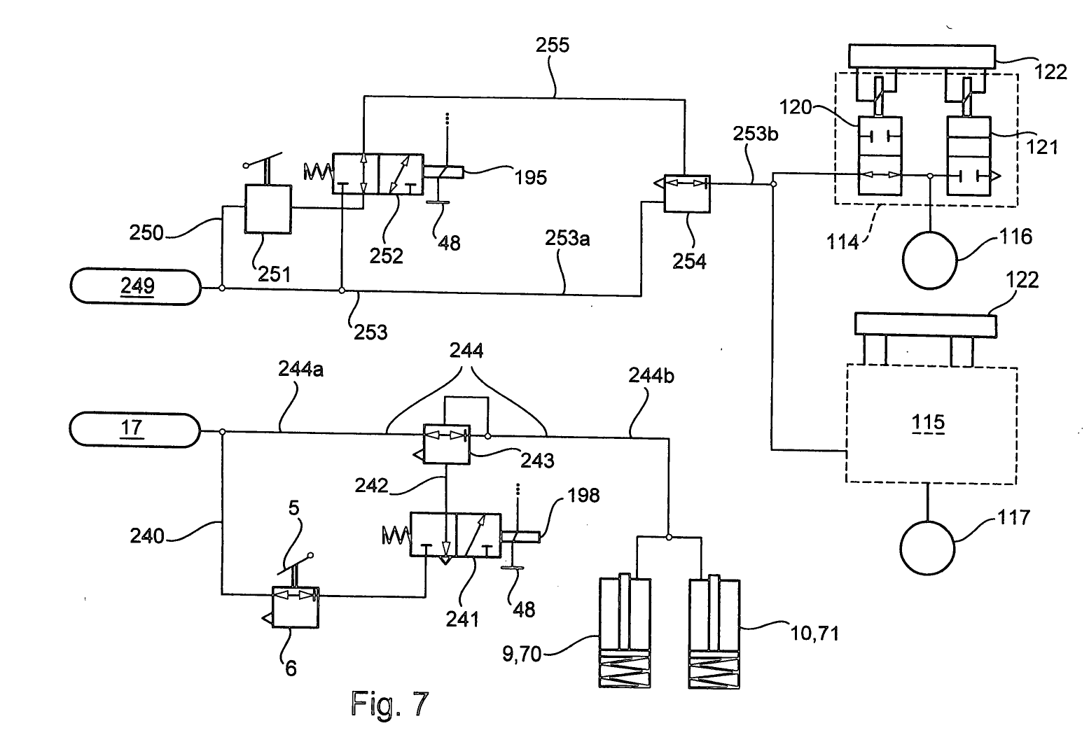

The pneumatic part of the third exemplary embodiment of the emergency braking device 28 is shown in FIG. 7.

The first reservoir vessel 17 for the parking brake device of the vehicle is connected via a first fluid line 240 to a first emergency brake switching valve 241 which can be switched over between two switched positions by means of the electromagnet 198. If the fifth electromagnet 198 is energized, the first emergency brake switching valve 241 connects the first fluid line 240 fluidically to an actuation line 242 which leads to a control input of a parking brake relay valve 243. The parking brake control valve 6 is inserted into the first fluid line 240 and can be activated by means of the parking brake operator control element 5.

If the fifth electromagnet 198, which is assigned to the first emergency brake switching valve 241, is not energized, the first emergency brake switching valve 241 vents the feed line 242 to the atmosphere and shuts off the first fluid line 240.

If the parking brake relay valve 243 is inserted into a first pressure line 244 which connects the first reservoir vessel 17 provided for the parking brake device to the parking brake actuators 9, 10, which at the same time form the emergency brake actuators 70, 71. The parking brake relay valve 243 divides the first pressure line 244 into a first line section 244a which leads from the first reservoir vessel 17 to the parking brake relay valve 243, and into a second line section 244b which connects the emergency brake actuators 70, 71 to the parking brake relay valve 243.

If the actuation line 242 to the parking brake relay valve 243 becomes pressureless, the parking brake relay valve 243 goes into a state which vents the line section 244b of the first pressure line 244 to the atmosphere so that the emergency brake actuators 70, 71 go into their emergency braking state which acts on the assigned wheels in a braking fashion. On the other hand, if the actuation line 242 to the parking brake relay valve 243 has pressure applied to it, the parking brake relay valve 243 connects the two line sections 244a, 244b of the first pressure line 244 so that a fluidic connection is brought about between the emergency brake actuators 70, 71 and the first reservoir vessel 17, and the emergency brake actuators 70, 71 release the assigned wheels.

Furthermore, a second reservoir vessel 249 is provided which is assigned to the service brake device of the vehicle. This second reservoir vessel 249 is connected fluidically by means of a second fluid line 250 via a service brake valve 251 to a second emergency brake switching valve 252 which can be switched over between two switched positions by means of the fourth electromagnet 195. A further input of the second emergency brake switching valve 252 is connected directly via a second pressure line 253 to the second reservoir vessel 249 which is provided for the service brake device.

The second pressure line 253 also connects the second reservoir vessel 249 to brake pressure modulators 114, 115 which are each assigned to a wheel brake device 116, 117 on the front axle of the vehicle. The brake pressure modulators 114, 115 each have an inlet valve 120 and an outlet valve 121 and are constructed in a manner known per se. Such brake pressure modulators are used in known ABS systems so that more details are not given on their situation. The brake pressure modulators 114, 115 are actuated by way of example by a corresponding control device 122 of an ABS system.

A service brake relay valve 254 which divides the second pressure line 253 into a first line section 253a to the second reservoir vessel 249 and into a second line section 253b to the brake pressure modulators 114, 115 is inserted into the second pressure line 253.

At the output end, the second emergency brake switching valve 252 is connected via an actuation line 255 to a control input of the service brake relay valve 254.

If the fourth electromagnet 195 which switches over the second emergency brake switching valve 252 is energized, the second emergency brake switching valve connects its inlet, connected to the second pressure line 253, fluidically to the actuation line 255 which leads to the service brake relay valve 254. As a result, an actuation pressure is generated in this actuation line 255 and said pressure moves the service brake relay valve 254 into a position in which it connects the two line sections 253a and 253b of the second pressure line 253 so that brake pressure is fed from the second reservoir vessel 249 to the brake pressure modulators 114, 115.

On the other hand, if the fourth electromagnet 195 which is assigned to the second emergency brake switching valve 252 is not energized, it connects the actuation line 255 which leads to the service brake relay valve 254 to the second fluid line 250 into which the service brake valve 251 is inserted.

The third exemplary embodiment of the emergency braking device 28 according to FIGS. 6 and 7 operates as follows:

When the ignition is switched on, the positive supply voltage of, for example, +24 volts or +42 volts is present on the ignition voltage supply lines 143 and 144. The isolating relays 173 and 176 are not energized since the reset relays 212, 213 have not yet attracted and therefore no current flows through the isolation actuating lines 168, 169. Since the fifth and sixth switches of the two isolating relays 173 and 176 are embodied as NC switches, a current flows through the reset display lamp 206, and the fourth electromagnet 195, which actuates the second emergency brake switching valve 252, is energized. The wheel braking devices 116, 117 on the front axle of the vehicle are as a result moved into their braking position.

The fifth electromagnet 198 which actuates the first emergency brake switching valve 241 is not energized so that the emergency brake actuators 70, 71 also assume their braking position.

The illuminated reset display lamp 206 indicates that the reset button 202 must be pressed. As a result, the switching coils of the reset relays 212, 213 are energized and the reset relays 213, 214 attracts. This results in the two isolating relays 173, 176 also attracting since a current flows through their switching coils 172, 175 as long as no emergency braking operation has been triggered by means of the emergency brake operator control device 34.

As a result of the two isolating relays 173, 176 having attracted, in each case their controlled isolating switches 1 to 4 and 7 close, whereas their respective isolating switches 5 and 6 open. The reset display lamp 206 goes out. The fourth electromagnet 195 is no longer energized so that no emergency braking pressure is fed any longer at the two front wheel brakes 116, 117 via the second emergency brake switching valve 252 and the service brake relay valve 254. The fifth electromagnet 198 which actuates the first emergency brake switching valve 241 is then energized, as a result of which the parking brake relay valve 243 applies brake pressure to the emergency brake actuators 70, 71 so that they release the assigned wheels. Furthermore, the thirteenth switching coil 221 of the bypass relay 220 of the run-up bypass 219 is energized so that the first bypass switch 222 connects the second isolation actuating line 169 to the bypass output line 186. As soon as the electro-pneumatic brake system is operationally ready and can supply an output voltage to the status output 26 of its brake control device 25, a current flows from the status output 26 to the vehicle frame 48 through the bypass display lamp 226 so that the illuminated display lamp 226 indicates the operational readiness of the service brake device.

At this time, the reset button 202 can be released again, causing the bypass relay 220 to drop out and change to its position shown in FIG. 6. The bypass display lamp 226 goes out and the electrical connection between the second isolation actuating line 169 and the bypass output line 186 is disconnected.

When the engine is started, the voltage at the status output 26 of the brake controller 25 may drop severely and trigger an emergency braking operation. For this reason, the engine starter bypass 230 is provided, said bypass serving to disconnect the connection to the status output 26 while the engine is starting, and to connect the actuation line 225 to the voltage supply line 41 of the vehicle instead of to the status output voltage, so that no undesired triggering of the emergency braking operation is brought about when the engine starts.

The emergency braking operation is triggered if one of the emergency brake switching relays 151 or the externally actuable emergency brake switching relays 152 of the first triggering arrangement 146 or of the second triggering arrangement 147 drops out, i.e. if its switching coil 150 or 163 is no longer energized.

If one of the emergency brake switching relays 151 of the first triggering arrangement 146 drops out, current no longer flows through the second isolation actuating line 169, as a result of which the second isolating relay 176 drops out. If one of the emergency brake switching relays 151 of the second triggering arrangement 147 drops out, no current flows through the first isolation actuating line 168 any more and the first isolating relay 173 drops out.

If one of the externally actuable emergency brake switching relays 162 drops out, there is no current flowing either through the first isolation actuating line 168 or through the second isolation actuating line 169 so that both isolating relays 173, 176 drop out.

If at least one of the two isolating relays 173, 176 has dropped out, the fourth electromagnet 195 which actuates the second emergency brake switching relay 252 is energized, while the fifth electromagnet 198 which actuates the first emergency brake switching valve 241 is not energized. As already described in conjunction with FIG. 7, this then leads to a situation in which the wheel brake devices 116, 117 of the front axle of the vehicle have pressure applied to them and brake the assigned wheels, and the emergency brake actuators 70, 71 on the rear axle also go into their emergency braking switched position.

By pressing the reset button, the emergency braking operation or the emergency braking state of the brake system can be cancelled again, the sequence running again as explained above in conjunction with the switch-on operation.

The two isolating relays 173, 176 and the fourth electromagnet 195 which actuates the second emergency brake switching valve 252 are illustrated in FIG. 8. FIG. 8 thus shows the electrical part of a fourth exemplary embodiment of the emergency braking device 28, the other electrical components being connected to one another, as illustrated in FIG. 6. The difference between the exemplary embodiments in FIG. 6 and FIG. 8 is simply that the fourth electromagnet 195 is not connected to the fifth isolating switches 188 and 192 of the two isolating relays 176 and 173, which are also embodied as NC switches, as is illustrated in FIG. 6, but rather according to FIG. 8 on the one hand it is connected to the seventh isolating switch 258 of the second isolating relay 176 and to the seventh isolating switch 259 of the first isolating relay 173, in each case at the output end. When the switching coil 175 or 172 is not energized, these seventh isolating switches 258, 259 of the isolating relays 176 and 173 are opened, and when the switching coil 175 or 172 is energized they are closed. Therefore, in contrast to the third exemplary embodiment, the fourth electromagnet 195 which actuates the second emergency brake switching valve 252 in the fourth exemplary embodiment of the emergency braking device 28 is not energized when the emergency braking operation is triggered.

The pneumatic part of the fourth exemplary embodiment of the emergency braking device 28 according to FIG. 9 is therefore changed slightly in comparison with the third embodiment according to FIG. 4, identical parts being provided with identical references.

In contrast to the third exemplary embodiment according to FIG. 7, in the fourth embodiment according to FIG. 9 the second emergency brake switching valve connects, in the nonenergized state of the assigned fourth electromagnet 195, the second reservoir vessel 259, provided for the service brake device, to the actuation line 255. If the fourth electromagnet 195 is energized, it switches over the second emergency brake switching valve 252 into its other switched position, in which case it fluidically connects the actuation line 255 to the second fluid line 250 into which the service brake valve 251 is inserted. The connections to the second emergency brake switching valve 252 are entirely interchanged in FIG. 9 in comparison with the embodiment according to FIG. 7, and thus adapted to the changed actuation of the fourth electromagnet 195.

In addition, the pneumatic part of the fourth exemplary embodiment of the emergency braking device 28 has, according to FIG. 9, a safety relay valve 263 which is inserted into the actuation line 255 and whose control input is connected fluidically via a safety control line 264 to the line section 265 of the first fluid line 240, said section 265 running between the parking brake control valve 6 and the first emergency brake switching valve 241. The additional safety relay valve 263 serves to relieve the wheel brake devices 116, 117 on the front axle of the vehicle again when an emergency braking operation is triggered since these wheel brake devices 116, 117 are not designed to stay in their braking state over a relatively long time period. If the parking brake operator control element 5 is activated after an emergency braking operation, it is assumed that the vehicle is then in a safe stationary state. The safety control line 264 is then pressureless. When the safety control line 264 is pressureless, the safety relay valve 263 is then in a switched position in which it vents the line section 266 of the actuation line 255 from the safety relay valve 263 to the control input of the service brake relay valve 254 to the atmosphere. As a result, the line section 254b of the second pressure line 253 is also vented from the service brake relay valve 254 to the brake pressure modulators 114, 115 so that the wheel brake devices 116, 117 on the front axle release the assigned wheels. Otherwise, the pneumatic part of the fourth exemplary embodiment according to FIG. 9 is constructed in the same way as the pneumatic part of the third exemplary embodiment according to FIG. 7 so that at this point it is possible to refer to the description relating to FIG. 7.

Of course, the presented exemplary embodiments of the emergency braking device 28 can also be combined with one another. In particular, in all the exemplary embodiments it is additionally also possible to brake a connector trailer if an emergency braking operation has been triggered, as was described in the first exemplary embodiment.

1-21. (canceled)

22. A brake system for a vehicle which has a driverless operating mode, comprising:
a service brake device which can be activated manually by a service brake activator control element,
a parking brake device which can be activated manually by a parking brake operator control element, and
an emergency braking device including
an emergency brake actuator for actuating a wheel brake, wherein the emergency brake actuator actuates the wheel brake in an emergency braking operation,
an emergency brake operator control device for manually triggering the emergency braking operation, and
a monitoring device for automatically triggering the emergency braking operation if the monitoring device detects a predefined operating state of the vehicle in the driverless operating mode.

23. The brake system as claimed in claim 22, wherein the brake system is an electro-pneumatic brake system.

24. The brake system as claimed in claim 22, further comprising a single-circuit embodiment.

25. The brake system as claimed in claim 22, wherein the monitoring device monitors the operating state of the service brake device, and when a defect is detected in the driverless operating mode, the monitoring device automatically triggers the emergency braking operation.

26. The brake system as claimed in claim 22, wherein the monitoring device triggers the emergency braking operation if the vehicle is outside a predefined driving lane in the driverless operating mode.

27. The brake system as claimed in claim 22, wherein the emergency braking operation is triggered by an electrical triggering signal.

28. The brake system as claimed in claim 22, wherein the emergency brake actuator is mechanically pre-stressed into a position of rest in such a way that when the emergency brake actuator is in the position of rest the wheel brake is applied, and wherein the wheel brake is releasable by the emergency brake actuator fluidically or electrically.

29. The brake system as claimed in claim 28, wherein the emergency brake actuator includes a spring brake cylinder.

30. The brake system as claimed in claim 22, wherein the emergency brake actuator includes a parking brake actuator of the parking brake device.

31. The brake system as claimed in claim 22, wherein the wheel brake, which is actuateable by the emergency brake actuator, is a rear wheel.

32. The brake system as claimed in claim 22, wherein when the emergency braking operation is triggered, a warning signal is brought about.

33. The brake system as claimed in claim 32, wherein the triggering of the emergency braking operation causes a drive assembly of the vehicle to be switched off.

34. The brake system as claimed in claim 33, wherein the emergency braking operation is triggered by an actuable electrical switch arrangement of the emergency braking device, which arrangement is located in a defined home state when in a currentless or voltageless state.

35. The brake system as claimed in claim 34, wherein the switch arrangement causes the drive assembly of the vehicle to switch off.

36. The brake system as claimed in claim 35, wherein the switch arrangement brings about the warning signal.

37. The brake system as claimed in claim 36, wherein the emergency braking device has a switchover device which can be actuated by the switch arrangement and is provided for switching over the wheel brake, which is provided with the emergency brake actuator, between the braking state and an enabling state which enables the wheel.

38. The brake system as claimed in claim 37, wherein the switchover device has a switchover valve which is fluidically connected to the emergency brake actuators and can be actuated electrically.

39. The brake system as claimed in claim 22, wherein the emergency brake operator control device includes a plurality of emergency brake operator control elements, which can be activated manually, are arranged at various locations on the vehicle.

40. The brake system as claimed in claim 22, wherein the emergency braking operation can be triggered independently of an activation of the emergency brake operator control element and/or of the parking brake operator control element.

41. The brake system as claimed in claim 22, further comprising a coupling device for coupling a trailer or semitrailer to the vehicle has a trailer control valve which, when the emergency braking operation is triggered, switches over a trailer braking device into the braking state in order to brake at least a wheel of a trailer axle so that both the vehicle and the trailer or semitrailer are braked.

42. The brake system as claimed in claim 22, wherein, when the service brake system is operationally capable, the wheel brake of the service brake device is also switched over into its brake state in addition to the emergency brake actuator when the emergency braking operation is triggered.
